(19) United States
(12) Patent Application Publication
(10) Pub. No.: US 2013/0064338 A1
(43) Pub. Date: Mar. 14, 2013

(54) COMPOSITE TARGET

(71) Applicants: Hiroshi MATSUMOTO, Tsukuba-shi (JP); Hitoshi KOBAYASHI, Tsukuba-shi (JP); Masakazu YOSHIOKA, Tsukuba-shi (JP); Toshikazu KURIHARA, Tsukuba-shi (JP)

(72) Inventors: Hiroshi MATSUMOTO, Tsukuba-shi (JP); Hitoshi KOBAYASHI, Tsukuba-shi (JP); Masakazu YOSHIOKA, Tsukuba-shi (JP); Toshikazu KURIHARA, Tsukuba-shi (JP)

(73) Assignee: Inter-University Research Institute Corporation High Energy Accelerator Research Organization, Tsukuba-shi (JP)

(21) Appl. No.: 13/569,587

(22) Filed: Aug. 8, 2012

Related U.S. Application Data
(60) Provisional application No. 61/521,524, filed on Aug. 9, 2011.
(60) Provisional application No. 61/623,180, filed on Apr. 12, 2012.

(30) Foreign Application Priority Data
Mar. 28, 2012 (JP) 2012-074598

(51) Int. Cl. H05H 3/06

(52) U.S. Cl. 376/108

(57) ABSTRACT

The present invention provides a target capable of reducing radioactivation of a member due to protons. The present invention uses a novel target configured by compositing a beryllium material or a lithium material and a carbon-series material for reducing the radioactivation of the member due to the protons.

### CROSS-REFERENCE TO RELATED APPLICATIONS

This application is based upon and claims the benefit of priority of the prior Japanese Patent Application No. JP2012-074598, filed on Mar. 28, 2012, the entire contents of which are incorporated herein by reference.

### FIELD

The present invention relates generally to a target for generating neutrons by colliding protons with the target. More particularly, the present invention provides a novel target for generating the neutrons by use of low-energy protons, and provides a target for solving a thermal problem of the target and reducing radioactivation of a target member etc due to the protons and the neutrons.

### BACKGROUND

In recent years, neutron generating methods and neutron generating apparatuses for Boron Neutron Capture Therapy (BNCT) expected as a selective cancer therapy have been actively researched and developed. These methods and apparatuses are disclosed in, e.g., Patent documents 1-12.

Patent document 1 (Japanese Patent Application Laid-Open Publication No.H11-169470) is characterized in that the neutrons are generated in a manner that causes Li (d,n) reaction by colliding, e.g., heavy proton beams having a kinetic energy of 30 MeV-40 MeV of a Radio Frequency Quadrupole Linac (linear accelerator)) with lithium, and thermal neutrons/epithermal neutrons for medical care are generated via a neutron decelerating material.

Patent document 2 (Japanese Patent Application Laid-Open Publication No. 2000-162399) relates to the target for generating the neutrons and is characterized by using Nb, Pt, Au, Al, Be, Cr, stainless steel each defined as a low hydrogen absorbent or tungsten coated with an alloy thereof in order to improve corrosion resistance against a cooling material of the target with which highly intensive proton beams are collided.

Patent document 3 (Japanese Patent Application Laid-Open Publication No. 2003-130997) is characterized in that non-thermal nuclear fusion reaction is induced by colliding heavy hydrogen ion beams with liquid lithium or a surface of an alloy of a metal having catalytic action of the nuclear fusion reaction, thereby generating the neutrons.

Patent document 4 (Japanese Patent Application Laid-Open Publication No. 2006-47115) is characterized in that the neutrons containing a nuclear fragmentation reactive substance are generated by colliding the proton beams having an energy equal to or larger than 20 MeV, which are generated by a cyclotron etc, with the heavy metal such as tantalum and tungsten, and the thermal neutrons/epithermal neutrons for medical care are generated in a way that removes the harmful nuclear fragmentation reactive substance and harmful fast neutrons from the generated neutrons via a filter configured to include a neutron decelerating unit and lead.

Patent document 5 (Japanese Patent Application Laid-Open Publication No. 2006-155906) discloses a neutron generating method and a neutron generating apparatus based on an FFAG-ERIT (Fixed Field Alternating Gradient- Emittance Recovery Internal Target) method. Then, the patent document 5 is characterized in that the neutrons are generated by colliding the proton beams or the heavy proton beams having the energy equal to or larger than 11 MeV but smaller than 15 MeV, which are circularly intensified by a cyclone type proton storage ring, with a made-of-beryllium target provided within this ring, and the thus-generated neutrons are adjusted into the thermal neutrons/epithermal neutrons for medical care via a decelerating material of heavy water etc.

Patent document 6 (Japanese Patent Application Laid-Open Publication No. 2006-196353) discloses a target for generating the neutrons by colliding the proton beams having an output of about 30 kW and an energy of about 11 MeV, which are accelerated by the RFQ Linac and a drift tube Linac, with the metal target. Further, this patent document 6 discloses that the target is the metal target and preferably the target made of beryllium. Then, the patent document 6 is characterized in that a thickness of the target is set substantially equal to or slightly larger than a range of the proton beam in the same target, and the target is cooled via a metal plate having a heat conduction area that is substantially equal to or larger than a heat conduction area of the target in order to cool the target.

Patent document 7 (Japanese Patent Application Laid-Open Publication No. 2008-22920) is characterized in that the fast neutrons of 10 key or more are generated by colliding the proton beams of 11 MeV with the target made of the beryllium by employing the linear accelerator, and the generated neutrons are let through the decelerating material of the heavy water etc and are thereby adjusted into the epithermal neutrons of less than 10 keV or the thermal neutrons of 0.5 eV or smaller.

Patent document 8 (Japanese Patent Application Laid-Open Publication No. 2007-303983) is characterized in that a lithium target manufacturing method is a method of press-fitting a rolled lithium thin film onto a substrate made of copper.

Patent document 9 (Japanese Patent Application Laid-Open Publication No. 2009-047432) is characterized in that a made-of-lithium target for generating the neutrons by colliding the protons having an energy slightly larger than a threshold value (about 2 MeV) of Li (p,n) reaction with the target, has a target structure for preventing the lithium from being melted, and this target structure is a structure of notching in a conical shape a block including a cooling mechanism and adhering the lithium thin film coated with the beryllium adhered onto a backing foil substrate onto the surface formed with the notch in the conical shape.

Patent document 10 (U.S.P 459,793) is characterized in that a made-of-lithium target for generating the neutrons has a lithium particle structure for preventing lithium particles from being melted and preventing a leakage of lithium liquefied by the generated heat, and this structure is a structure of sequentially coating the lithium particles in the sequence of sintered carbon, silicon carbide and zirconium carbide.

Patent document 11 (International Publication 08/060663) is characterized in that the made-of-lithium target for BNCT is a lithium target in which the lithium is adhered onto an iron substrate, a tantalum substrate or a vanadium substrate.

Patent document 12 (U.S.P Application 2010/0067640) is characterized in that the made-of-lithium target for generating the neutrons by colliding the protons having an output of 20 mA-50 kW and an energy of 2.5 MeV with the target has a target structure for preventing the lithium from being melted, and this target structure is a structure of providing a palladium thin film on the surface of the cone-shaped heat conductive plate including the cooling mechanism and adhering the lithium thin film onto the palladium thin film.

The methods and the apparatuses disclosed in the patent documents 1-7 given above, however, require high-energy proton beams in which an acceleration energy of the proton beams or the heavy proton beams collided with the target is at least 11 MeV. Therefore, the methods and the apparatuses disclosed in the patent documents 1-7 given above have the following problems in terms of a practical use. That is, a large-sized accelerator for generating the proton beams or the heavy proton beams is required. Conspicuous radioactivation of a member of the target etc is caused by the high-energy proton beams. A large-sized cooling device is needed for cooling the target. It is hard to handle the target in the case of a liquid target. In the case of a solid-state target, a comparatively thick target material for preventing the target from being melted is adhered onto a metallic support member having thermal conductivity. When the target material for generating the neutrons is made of a metal such as a heavy metal, the metal is mixed with a considerable amount of fast neutrons that are extremely harmful to a human body and have high radioactivation of the member of the apparatus, and hence there is required a large scale decelerating apparatus for decelerating the primarily generated neutrons. A special safe management system is needed for absorbing or removing the harmful and highly radioactive proton beams, neutrons and nuclear reaction secondary substances. An embrittlement preventive measure of the target material due to active hydrogen as a reaction by-product is taken. Especially, the problem of the radioactivation by the member of the target etc due to the proton beams and the neutrons is a problem of radiation exposure received from the radioactive member and is therefore the critical problem that should be solved. Further, as seen in the patent document 6, in the case of using the solid-state target of the beryllium, it is indispensable to remove the heat generated at the target, and therefore such a contrivance is proposed as to enlarge a heat conduction area of the metallic support member for supporting the target. It is, however, difficult to prevent exfoliation of a bonding interface due to a thermal stress, the embrittlement and the exfoliation of the support member due to the active hydrogen. Moreover, in the case of the solid-state targets each made of the lithium that are disclosed in patent documents 8-12 given above, there are proposed the contrivance about the structure of the heat conductive plate serving as the support member of the lithium thin film and the method of coating the lithium particles with the refractory material in order to prevent the melting of the lithium (the melting point is approximately 180° C.) having a low melting point. It is not, however, expected from these methods to tremendously improve the cooling efficiency, and it is considered difficult to prevent the lithium from being melted. For solutions of the problems described above, it is highly desired to solve the thermal problem of the target that arises due to the collision of the proton and to develop the target for reducing the radioactivation of the member of the target etc due to the protons and the neutrons. None of the target capable of solving the problems given above is known at the status quo.

It is an object of the present invention, which was devised under such circumstances, to provide a novel target for generating the neutrons by use of low-energy protons. More specifically, it is another object of the present invention to provide a novel neutron generation target capable of generating the neutrons by irradiating low-energy protons, reducing radioactivation of a member of the target etc due to the protons and the neutrons and fundamentally solving a thermal problem of the target material and a problem of hydrogen embrittlement.

### SUMMARY

The present inventors, as a result of repeatedly making energetic researches for attaining the objects given above, found out that a target configured by compositing a beryllium material and a carbon-series material and a target configured by compositing a lithium material and the carbon-series material, are highly effective as the targets, and reached the completion of the present invention based on this knowledge.

Namely, one aspect of the present invention is a composite type target including: a target to generate neutrons by colliding protons with the target and to be configured by compositing a beryllium material and a carbon-series material; a vacuum seal to be applied to the target; and a cooling mechanism to be formed with a flow path for a coolant and to be collaterally fitted to the target.

Another aspect of the present invention is a composite type target including: a target to generate neutrons by colliding protons with the target and to be configured by compositing a lithium material and a carbon-series material; a vacuum seal to be applied to the target; and a cooling mechanism to be formed with a flow path for a coolant and to be collaterally fitted to the target.

### BRIEF DESCRIPTION OF THE DRAWINGS

FIG. 1 is a sectional view illustrating a composite type target in which a target according to an embodiment is a target configured by bonding a beryllium material (or a lithium material) and a carbon-series material together, a vacuum seal is applied to the surface of the target, and a cooling mechanism formed with a coolant flow path is collaterally fitted to the target, also illustrating a composite type target in which the cooling mechanism formed with the coolant flow path is collaterally fitted to a side surface of the target, and a coolant flow path is independently formed also in an interior of the target;

FIG. 2 is a sectional view illustrating a composite type target in which the target according to the embodiment is a target configured by bonding the beryllium material (or the lithium material) and the carbon-series material together, the vacuum seal is applied to the surface of the target, and the cooling mechanism formed with the coolant flow path is collaterally fitted to the target, also illustrating a composite type target in which the cooling mechanism formed with the coolant flow path is collaterally fitted to the side surface of the target, the coolant flow path is formed also in the interior of the target, and the internal coolant flow path is connected to the coolant flow path of the cooling mechanism;

FIG. 3 is a sectional view illustrating a composite type target in which the target according to the embodiment is a target configured by alternately stacking a layer of the beryllium material (or a layer of the lithium material) and a layer of the carbon-series material on each other, the vacuum seal is applied to the surface of the target, and the cooling mechanism formed with the coolant flow path is collaterally fitted to the target, also illustrating a composite type target in which the cooling mechanism formed with the coolant flow path is collaterally fitted to the side surface of the target;

FIG. 4 is a schematic view illustrating a neutron generating method using the composite type target of the present invention according to the embodiment;

FIG. 5 is a schematic view illustrating a neutron generating apparatus using the composite type target of the present invention according to the embodiment;

FIG. 6 is a sectional view illustrating a target for a comparison; and

FIG. 7 is a sectional view illustrating a composite type target having a structure in which the target according to the embodiment is a composite type target having a configuration of “beryllium material—carbon-series material—lithium material—carbon-series material”, the vacuum seal is applied to the surface of the target, the cooling mechanism formed with the coolant flow path is collaterally fitted to the target, the coolant flow path is formed also in the interior of the target, and this coolant flow path is connected to the cooling mechanism.

### DESCRIPTION OF EMBODIMENTS

One invention of the present application relates to a target configured by compositing a beryllium material and a carbon-series material and a composite type target configured by applying a vacuum seal to the target and collaterally fitting a cooling mechanism to the target; and another invention relates to a target configured by compositing a lithium material and the carbon-series material and a composite type target configured by applying the vacuum seal to the target and providing the cooling mechanism to the target. Functions of the composite type target according to the present invention are “a reduction of radioactivation of a member due to protons and neutrons” and “effective cooling of the target” in addition to a main function “the neutron generation based on nuclear reaction”. The present invention relates to the composite type targets each configured by compositing the two types of materials, and hence the functions of the target can be shared in terms of roles by the two types of materials. To be specific, one function is that the neutrons having a low energy can be generated by use of the protons having the low energy owing to properties possessed by the beryllium material and the lithium material, which are peculiar to the protons. Another function is that it is feasible to remarkably reduce the radioactivation of the member of the target etc due to the protons and the neutrons owing to properties possessed by the carbon-series materials, which are peculiar to the protons and the neutrons. Still another function is that the heat generated by the target can be promptly conducted to the surface of the target owing to excellent thermal diffusibility possessed by the carbon-series material. Yet another function is that the composition of the beryllium material (or the lithium material) and the carbon-series material enables the surface areas of these materials to be tremendously improved, i.e., enables heat conduction areas to be tremendously improved, and it is therefore feasible to conduct the heat generated at the target to the surface of the target promptly. A further function is that the conducted heat is discharged outside the system through the cooling mechanism collaterally fitted to the target and formed with a coolant flow path, whereby the target can be efficiently cooled. Moreover, owing to this efficient cooling, secondary effects are acquired, such as being capable of using even low-melting lithium (a melting point: approximately 180° C.) which has hitherto been difficult to be used as a solid-state target, preventing hydrogen embrittlement of the target material, preventing exfoliation at a bonding interface between the beryllium material (or the lithium material) and the carbon-series material, and preventing blowout and fusion of beryllium (or lithium) even when employing beryllium (or lithium) thinner than beryllium (or lithium) hitherto used because of enabling the carbon-series material to function as a support material and a cooling material for the beryllium material (or the lithium material). Moreover, the nuclear reaction can occur under vacuum by virtue of the vacuum seal applied to the target, and further the target material can be prevented from being deteriorated by oxidation upon a contact with the atmosphere. Furthermore, the cooling mechanism provided in the target can cool the target by actually discharging the heat generated at the target outside the system. With these effects, the composite type target according to the present invention solves the thermal problem of the target and can generate stably the neutrons exhibiting the low energy while reducing the radioactivation of the member of the target etc . .

Further, it is possible to use a linear accelerator defined as an accelerator, which is drastically downsized as compared with a conventional synchrotron or cyclotron serving as a source of generating the protons colliding with the composite type target of the present invention. Therefore, the medical neutrons for BNCT (Boron Neutron Capture Therapy) can be generated by providing the composite type target of the present invention in the small-sized linear accelerator that can be installed at a small-scale medical institution.

As elucidated above, the main reason why the target according to the present invention is configured by compositing the beryllium material (or the lithium material) and the carbon-series material, lies in sharing the functions of the target by the two types of materials. Specifically, the reason for using the beryllium material and the lithium material is mainly for generating the neutrons having the low energy through collisions of the protons exhibiting the low energy. In this connection, the beryllium material enables ⁹Be (p, n) reaction to occur by the protons of 4 MeV-11 MeV, while the lithium material enables ⁹Li (p, n) reaction to occur by the protons of 2 MeV-4 MeV. Further, the reason for using the carbon-series material as another material of the target is chiefly for reducing the radioactivation due to the protons and the neutrons and promptly conducting the heat generated at the target to the surface of the target by virtue of the high thermal diffusibility of the carbon-series material. Furthermore, it is because the carbon-series material, though having neutron generation efficiency that is smaller than those of the beryllium material and the lithium material, enables the neutrons to be generated by collisions of the protons.

The beryllium material in the present invention represents a single element material (which is a simple substance metal of the beryllium element and hereinafter be referred to as beryllium) of beryllium element selected from within the elements of the second group of the periodic table, a beryllium compound and a beryllium composite material. Moreover, the lithium material in the present invention represents a single element material (which is a simple substance metal of the lithium element and hereinafter be referred to as lithium) of lithium element selected from within the elements of the first group of the periodic table, a lithium compound and a lithium composite material. The reason why the beryllium, the beryllium compound and the beryllium composite material are generically termed the beryllium material and why the lithium, the lithium compound and the lithium composite material are generically termed the lithium material is that the principle of generating the neutrons is based on the nuclear reaction peculiar to the specified element. Namely, it is because the principle of generating the neutrons by irradiating the target with the accelerating protons is based on the physical nuclear reaction between the protons and atoms of the specified element contained in the target, and therefore the neutrons are generated by the same nuclear reaction also when the target is composed of the compound of the specified element and the composite material as the case of the simple substance of the specified element. That is, according to the present invention, it is possible to use the beryllium compound, the beryllium composite material, the lithium compound and the lithium composite material other than the beryllium and the lithium. The target involves using the compound of the specified element and the composite material, in which case it is desirable to use such a type of element that the elements excluding the specified elements (the beryllium element and the lithium element) contained in the compound and the composite material do not undergo the radioactivation by the protons and the neutrons and that a harmful substance is not generated due to the reaction to byproduct hydrogen atoms. These elements can be exemplified such as boron, carbon, silicon, nitrogen, phosphor, oxygen and sulfur.

The beryllium material according to the present invention represents the beryllium, the beryllium compound and the beryllium composite material. The beryllium compound can be exemplified such as beryllium oxide (BeO), beryllium nitride (Be₃N₂), beryllium carbide, beryllium hydroxide (Be(OH)₂), beryllium acetate (Be(CH₃CO₂)₂), beryllium carbonate (BeCO₃), beryllium sulfate (BeSO₄), beryllium nitrate (Be(NO₃)₂), beryllium phosphate (Be₃(PO₄)₂), beryllium silicate (Be₂SiO₄), beryllium aluminate (Be(AlO₂)₂), beryllium titanate (BeTiO₃), beryllium niobate (Be(NbO₃)₂) and beryllium tantalite (Be(TaO₂)₂), but is not limited to these materials. Further, the beryllium composite material can be exemplified such as beryllium glass such as beryllium borate glass and beryllium metaphosphate glass, beryllium glass ceramic containing beryllium glass as a main component, a beryllium alloy such as a magnesium beryllium alloy and an aluminum beryllium alloy, beryllium ceramic containing beryllium oxide as a main component, beryllium solution ceramic solved with the beryllium element and beryllium-doped endohedral fullerene, but is not limited to these materials. Among the beryllium materials given above, the beryllium and the beryllium oxide are most preferable because of having the high melting point (the melting point of the beryllium is approximately 1278° C., and the melting point of the beryllium oxide is 2570° C.) though a threshold value (about 4 MeV) of the ⁹Be (p, n) reaction is comparatively high. Other preferable materials are the beryllium glass, the beryllium ceramic and the beryllium-doped endohedral fullerene from which the single substance of the beryllium is not eluted.

The lithium material according to the present invention represents the lithium, the lithium compound and the lithium composite material. The lithium compound can be exemplified such as lithium oxide (Li₂O), lithium nitride (Li₃N), lithium carbide, lithium hydroxide (LiOH), lithium acetate (LiCH₃CO₂), lithium carbonate (Li₂CO₃), lithium sulfate (Li₂SO₄) lithium nitrate (LiNO₃), lithium phosphate (Li₃PO₄), lithium silicate (Li₄SiO₄), lithium aluminate (LiAlO₂), lithium iron phosphate (LiFePO₄), lithium iron fluoro-phosphate (Li₂FePO₄F), lithium titanate (Li₄Ti₅O₁₂), lithium titanate (Li₂TiO₃) lithium niobate (LiNbO₃) and lithium tantalite (LiTaO₂) but is not limited to these materials. Furthermore, the lithium composite material can be exemplified such as lithium glass such as lithium borate glass, lithium silicate glass and lithium bisilicate glass, lithium glass ceramic containing the lithium glass as a main component, a lithium alloy such as a magnesium lithium alloy and an aluminum lithium alloy, lithium ceramic containing lithium oxide as a main component, lithium solution ceramic solved with the lithium element and lithium-doped endohedral fullerene, but is not limited to these materials. Among the lithium materials given above, the lithium is most preferable because of having the low threshold value (about 2 MeV) of the ⁷Li (p, n) reaction though exhibiting the low melting point. Other preferable materials are the lithium glass, the lithium glass ceramic and the lithium-doped endohedral fullerene from which the single substance of the lithium is not eluted.

The main reason why the carbon-series material is set as another material of the composite type target according to the present invention is that the carbon-series material is effective in reducing the radioactivation caused by the protons and the neutrons as compared with a metal group and that the carbon-series material is superior to the metal group in terms of the thermal diffusibility to diffuse the heat generated at the target. Another reason is that the carbon-series material is preferable to the metal group in terms of generating the low-energy neutrons in which fast neutrons being harmful and exhibiting the high radioactivation are decreased. The carbon-series material according to the present invention represents a single element material (which will hereinafter be referred to as the carbon material) of the carbon element selected from within the elements of the fourteenth group of the periodic table, a carbon-series compound and a carbon-series composite material. Then, according to the present invention, the carbon material, the carbon-series compound and the carbon-series composite material are generically termed the carbon-series material.

The preferable carbon-series material is a material being hard to undergo the radioactivation, being small of absorption of the thermal neutron and the epithermal neutron, having a high neutron deceleration effect, having high durability against the radioactive rays, exhibiting the high melting point to endure the thermal load, being excellent of the thermal diffusibility for diffusing the heat generated at the target, having an outstanding bond performance with respect to the beryllium material and the lithium material, and being capable of generating the neutrons. Among these carbon-series materials, the carbon materials can be exemplified such as graphitic materials, porous carbon, diamond, diamond-like carbon (DLC), glassy carbon, carbon nanotubes, fullerenes, polyacetylene, carbynes, graphenes, carbon fibers, carbon nanofiber, volatile grown carbon fibers (VGCF) and carbon whisker but are not limited to these materials. Moreover, the carbon-series compound can be exemplified such as the carbon nitride and the silicon carbide but is not limited to these materials. Further, the carbon-series composite material can be exemplified such as carbon fiber reinforced plastic and carbon fiber reinforced ceramic but is not limited to these materials.

Among the carbon materials, preferable materials are the graphitic materials, the diamond, the carbon nanotubes, the carbynes, the graphenes, the carbon fibers, the carbon nanofiber, the VGCF and the carbon whisker, which have well-balanced physical properties, show superiority of the thermal conductivity and the thermal diffusibility but are hard to generate radioactive nuclides and also have, to be unexpected, a property of being hard to cause the hydrogen embrittlement. The graphitic material connotes the carbon material in which honeycomb layers (graphite layers) including a chain of six-membered rings of the carbon atoms (containing partially five-membered rings), which are strung in plane, are bonded by weak Van der Waals force to form a layered structure. Then, the graphitic material according to the present invention can be exemplified such as single crystalline graphite, highly oriented pyloritic graphite (HOPG), graphite, turbostratic graphite (graphite having a turbostratic microstructure) and amorphous graphite but is not limited to these materials. Generally, the graphitic materials are classified into the single crystalline graphite, the highly oriented pyloritic graphite, the graphite, the turbostratic graphite and the amorphous graphite depending on differences of crystallizability and orientation of the graphite layer. Further, the graphitic materials are classified into a CIP material (a compact into which a raw material of the graphite is molded in an isotropic way by a Cold Isostatic Press), an extruded material and a mold material depending mainly on molding methods. The graphitic material acquired via a graphitizing process after carbonizing the CPI material by baking is the graphite having an isotropic structure and an isotropic characteristic and is therefore called the isotropic graphite. The graphitic material acquired via the graphitizing process after carbonizing the excluded material by baking is the graphite having an anisotropic structure and an anisotropic characteristic and is therefore simply called the graphite. Then, this graphite category embraces those from the single crystalline graphite and the high-crystallinity/high-orientation graphite such as the HOPG and down to the low-crystallinity low-orientation graphite such as the turbostratic graphite. Moreover, the graphitic material acquired via the graphitizing process after carbonizing the mold material by baking is the graphite normally having an amorphous structure and an amorphous characteristic and is therefore called the amorphous graphite. Among the graphitic materials according to the present invention, the single crystalline graphite is such that a value of a coefficient of thermal conductivity on the surface (graphite surface) of the graphite layer is normally 1500 Wm⁻¹K⁻¹, and the diffusion coefficient of the heat (given by the coefficient of thermal conductivity per specific heat capacity) is approximately 3.4 m²h⁻¹. Further, among the graphitic materials according to the present invention, the isotropic graphite, though having the coefficient of thermal conductivity and the diffusion coefficient of the heat that are smaller than those of the single crystalline graphite, is isotropic in terms of the thermal conductivity and the thermal diffusibility in the same way as the metal material is. On the other hand, the coefficient of thermal conductivity of copper well known as the metal material having the high thermal conductivity is 400 Wm⁻¹K⁻¹, and the diffusion coefficient of the heat is about 0.42 m²h⁻¹. Accordingly, among the graphitic materials according to the present invention, the single crystalline graphite and the HOPG having the high-crystallinity/high-orientation as equivalent to the single crystalline graphite are preferable as the thermal conductive material for conducting and diffusing the heat generated at the target to and over the target surface along the graphite surface more promptly than the metal material, and the isotropic graphite is preferable as the thermal conductive material similarly to the metal material exhibiting the high thermal conductivity. Moreover, the carbon fibers, the carbon nanofiber, the carbon whisker, the carbon nanotubes, the carbynes and the graphenes, which have the high-crystallinity/high-orientation, are also preferable as the same reason. Further, the diamonds include the high-crystallinity/high-orientation diamonds such as the single crystalline diamond and the epitaxial diamond. Among the diamonds given above, the single crystalline diamond is such that a value of the coefficient of thermal conductivity is 2300 Wm⁻¹K⁻¹, and the diffusion coefficient of the heat is approximately 4.6 m²h⁻¹. Hence, the single crystalline diamond and the high-crystallinity/high-orientation epitaxial diamond equivalent thereto among the carbon materials according to the present invention are preferable as the thermal conductive materials for promptly conducting and diffusing the heat generated at the target toward the target surface in the isotropic way (three-dimensionally). The usable carbon materials according to the present invention have a bulk density that normally falls within a range of 1.5 gcm⁻³-3.5 gcm⁻³. In the present invention, the carbon material, of which the bulk density is less than 1.5 gcm⁻³, is not unusable, however, if less than 1.5 gcm⁻³, it might happen that the collisions among the carbon atoms, the protons and the neutrons become insufficient, and it is therefore preferable that the bulk density is equal to or larger than 1.5 gcm⁻³. Further, if the bulk density exceeds 3.5 gcm⁻³, a stable phase under the normal pressure is the diamond, so that the maximum value of the bulk density of the carbon material existing as the substance is approximately 3.5 gcm⁻³. The carbon materials utilized as the conventional industrial materials are usable as the carbon materials used in the present invention, and the carbon materials improved to have a much higher density are further preferable.

Moreover, the carbon-series material in the present invention can be formed into the carbon-series composite material by compositing at least one of the preferable carbon materials among the carbon-series materials with another carbon-series composite material other than these materials. One or plural carbon-series materials may be composited. These carbon-series materials can be exemplified by, as given above, the porous carbon, the diamond, the diamond-like carbon, the glassy carbon, the carbon nanotubes, the fullerenes, the polyacetylene, the carbynes, the graphenes, the carbon fibers, the carbon nanofiber, the VGCF, the carbon whisker, the carbon nitride, the silicon carbide, etc but are not limited to these materials. For example, the composite with the isotropic graphite can be attained by bonding the compact of the isotropic graphite to another compact of the carbon-series material, mixing the isotropic graphite with another carbon-series material, combining the isotropic graphite with another carbon-series material, and so on. A component ratio of the isotropic graphite is, though not particularly limited, normally equal to or larger than 50%. With this ratio being set, it is feasible to give a cooperative effect of the isotropic graphite with another carbon-series material. For example, the thermal conductivity and the thermal diffusibility of the target can be further improved by compositing the isotropic graphite with the diamond or carbon nanotube exhibiting the excellent thermal conductivity.

It is known that an average energy of the neutrons generated at the target is about one-fifth of the energy of the incident protons (Non-patent document 1: M. A. Lone, et. Al., Nucl. Instr. Meth. 143 (1977) 331.). Accordingly, it is presumed that the average energy of the neutrons generated by colliding the protons of 8 MeV with the beryllium material is approximately 1.6 MeV, and the average energy of the neutrons generated by colliding the protons of 3 MeV with the lithium material is approximately 0.6 MeV. The value of this average energy of the neutrons is within the energy range of the fast neutrons, and hence the generated neutrons need to be decelerated down to the energy of the thermal neutrons or the epithermal neutrons by use of the decelerating material for the medical use such as the BNCT. The carbon-series materials such as light water (H₂O), heavy water (D₂O), the beryllium (Be), the beryllium oxide (BeO) and the graphite (C), as compared with such a point that a ferrous metal like iron, a nonferrous metal like copper and the heavy metal like tungsten exhibit almost no property of decelerating the neutrons, have a neutron deceleration ratio (which is a value obtained by dividing a value of moderating power of the neutron by absorbing power of the neutron, in which a larger value implies a better decelerating material) that is 1000 times as large as the decelerating ratio of the metal described above. Therefore, these carbon-series materials are generally employed as the neutron decelerating materials for a nuclear reactor etc. Among these materials, the carbon-series material such as the graphite has the neutron decelerating ratio that is larger than the neutron decelerating ratio of the light water and has a neutron decelerating length (which is a migration length till the fast neutron is decelerated and becomes the thermal neutron, and is given as a square root of the Fermi age τcm²) that is as comparatively short as about 20 cm (the value is approximately 4 times as large as the neutron decelerating length of the light water and is approximately twice as large as the neutron decelerating length of the heavy water) (Non-patent document 2: Title: “Neutronics of Coupled Liquid hydrogen Cold Neutron Source” authored by Yoshiyuki Kiyanagi, Hideki Kobayashi and Hirokatsu Iwasa, Bulletin of the Faculty of Engineering, Hokkaido University, 151:101-109 (1990 Jul. 30)), and is the suitable material as the neutron decelerating material for acquiring the neutrons according to the present invention. Moreover, the carbon-series material such as the graphite is presumed to have the same neutron penetrability as the water has, and hence a neutron penetration ratio (I/I₀: a ratio of an intensity of the neutron after the penetration to an intensity of the incident neutron) in the carbon-series materials such as the graphite is estimated to be about 60% on the basis of measurement data (I/I₀=10^{-0.08T}, where Tcm is the penetration length of the neutron, and the incident neutron has an energy of 1 MeV) (Non-patent document 3: Practice Manual of Calculation of Shielding Radiation Facilities, 2007, compiled by Nuclear Safety Technology Center, a Public Interest Incorporated Foundation) of the neutron penetration ratio of the water on the assumption that a thickness of the carbon-series material like the graphite is, e.g., 3 cm. It is therefore presumed that the penetration of about 40% of the fast neutrons can be restrained. Further, for instance, if the thickness of the carbon-series material is set equal to or larger than 20 cm, the penetration of the fast neutrons is restrained almost completely, and it is presumed that the neutrons are acquired as the thermal neutrons and the epithermal neutrons.

Moreover, a reinforcing material can be properly added to the carbon-series material according to the present invention in order to improve the mechanical strength etc when used. A preferable reinforcing material is a material that is hard to undergo the radioactivation. This type of materials can be exemplified such as epoxy resins, glass fibers and a variety of ceramic materials but are not limited to these materials.

In the generation of the neutrons due to the collisions between the protons and the target, it is of much importance at all times how the heat generated at the target is efficiently discharged. Normally, the maximum value of the thermal load per unit surface area of the target is deemed to be a value obtained by dividing an output of the protons by the surface area of the target, and therefore a capacity of discharging the heat from the surface of the target must be designed to be equal or larger than the thermal load on the target. For example, the output of the protons needed for generating the neutrons for the medical use such as the BNCT is calculated to be at least 30 kW by way of a trial. Hence, supposing that the surface area of the target is 30 cm², it follows that the thermal load becomes 10 MWm⁻². The output of the protons is set, to be on the safe side, to a value to the greatest possible degree because a dosage of the generated neutrons becomes larger as the output gets higher. This being the case, however, one type of target material has hitherto been used, and therefore, in the case of irradiating the target material having a surface area of 30 cm² with proton beams exhibiting an output of, e.g., 30 kW, there is proposed a cooling method involving an intermediary of a heat conductive plate having a larger surface area than the target material has (Patent document 6) because of its being difficult to perform direct cooling based on water cooling of the surface of the target material. According to this method, however, it is practically difficult to employ the solid target using the material such as the lithium exhibiting the low melting point. By contrast, the composite type target according to the present invention, which is configured by compositing the beryllium material or the lithium material with the carbon-series material, is capable of diffusing the heat via the carbon-series material and can therefore increase the output of the protons further than the conventional output value, whereby even the protons with the output of about 100 kW can be used. The composite type target according to the present invention is effective in solving the thermal problem of the target as described above, and the composite of the beryllium material or the lithium material and the carbon-series material in the composite type target according to the present invention is highly effective as in the following discussion.

The composite in the present invention embraces not only simply bonding the beryllium material (or the lithium material) and the carbon-series material together but also mixing and combining these two materials and compositing based on surface working. In the composite type target according to the present invention, an interface is formed between the surfaces of the beryllium material (or the lithium material) and the carbon-series material by compositing these two materials. The heat generated at the target is discharged in principle through the thermal conduction and the thermal diffusion at the interface between the materials, and hence the composite of the beryllium material (or the lithium material) and the carbon-series material in the present invention is preferable. For example, in the target configured by bonding the beryllium material (or the lithium material) to the carbon-series material such as the single crystalline graphite and the isotropic graphite each exhibiting the superior thermal conductivity, the heat generated at the target can be promptly dissipated onto the target surface via the carbon-series material. For instance, in the target configured by molding a mixture of the powdered beryllium material (or lithium material) and the powdered carbon-series material, a specific surface area of the material can be made larger than the surface area of the bulk material depending on a particle size of the material, and it is therefore feasible to improve the thermal conductivity and the thermal diffusibility at the interface between the materials. For example, in the target containing the combination of the beryllium material (or the lithium material) and the carbon-series material, the direct thermal conduction via the interface between the two materials can be done. Moreover, a shape of a curved surface and a corrugated or rugged shape can be formed on the target surface and the surface of the target material by the surface working over the target and the target material, thereby enabling the surface area of the target to be larger than the plane area thereof and enabling the thermal conductivity and the thermal diffusibility at the interface between the materials to be improved. The heat, which is thus conducted promptly to the target surface through the thermal conduction and the thermal diffusion, can be discharged outside the actual system by the indirect or direct cooling mechanism provided on the side surface, in the interior or on the bottom surface of the target, whereby the target can be cooled. Note that the specific surface area of the target is a total sum of the specific areas of the beryllium material (or the lithium material) and the carbon-series material, which configure the target, and the plane area of the target connotes an area given when projecting the target surface on a parallel plane thereof. Further, the secondary effects of compositing the beryllium material (or the lithium material) and the carbon-series material are given, such as improving adhesion between the beryllium material (or the lithium material) and the carbon-series material, relaxing a thermal stress on the interface and preventing exfoliation on the interface.

As discussed above, the composite type target according to the present invention is capable of increasing the specific area of the target further than the plane area by compositing the beryllium material (or the lithium material) and the carbon-series material together. The specific area of the target is, when positively enlarging this specific area, is roughly estimated to be, preferably, twice or more as large as the plane area of the target. If the specific area of the target is twice or more as large as the plane area of the target, the thermal conduction to the target surface is speeded up, and it is therefore preferable that the heat can be efficiently discharged without providing the large heat conductive plate on the target surface. For instance, the surfaces of the beryllium material and the lithium material are formed with the corrugated or rugged shapes and grooves by use of the surface working method such as laser ablasion, whereby the specific area can be easily enlarged twice or more. The powdered beryllium material and the powdered lithium material are dispersed over the isotropic graphite and are molded in the target shape, whereby the specific area can be enlarged about 100 times. Furthermore, particles of the beryllium material and the lithium material are borne in minute holes of the porous carbon material by employing an impregnation method for adjusting a catalyst, whereby the specific area can be enlarged about 1000 times.

Concrete modes of the composite type target according to the present invention are exemplified as follows. For example, the beryllium material (or the lithium material) and the carbon-series material are bonded together and thus molded into the target. The surfaces of the beryllium material (or the lithium material) and the carbon-series material are formed with the corrugated or rugged shapes and thus molded into the target. The mixture of the powdered beryllium material (or lithium material) and the powdered carbon-series material is molded into the target. The particles of the beryllium material (or the lithium material) are dispersed into the porous carbon-series material, and the particle-dispersed material is molded into the target. The powdered carbon-series material is coated with the beryllium material (or the lithium material), and the beryllium- or lithium-coated material is molded into the target. Both of the beryllium material (or the lithium material) and the carbon-series material are combined and thus bonded and are molded into the target. Layers of the beryllium material (or the lithium material) and the carbon-series material, which have small thicknesses, are alternately stacked up and thereafter molded into the target. The mode of the composite type target is not, however, limited to those exemplified above. For instance, the surfaces of the beryllium material (or the lithium material) and the carbon-series material are formed with the grooves and the corrugated or rugged shapes and thus molded into the target, here the specific area of the target can be enlarged about several times. This configuration acquires an effect in restraining excessive thermal concentration. The specific area of the powdered material is by far larger than the specific area of the bulk material, so that the mixture of the powdered beryllium material (or lithium material) and the powdered carbon-series material is molded into the target, whereby the specific area of the target can be improved about 100 times as large as the plane area. For the same reason, the particles of the beryllium material (or the lithium material) are dispersed into the carbon-series material, and the particle-dispersed material is molded into the target, whereby the specific area of the target can be enlarged about 1000 times as large as the plane area. Further, the heat conduction area can be tremendously enlarged by increasing the number of the alternately-stacked layers of the beryllium material (or the lithium material) and the carbon-series material each having the small thickness.

The method of compositing the target materials in the composite type target according to the present invention is properly determined corresponding to the composite modes, the types, the thicknesses, etc of the materials to be used but is not limited to the specified working methods. For example, the composite based on bonding the beryllium material to the carbon-series material can be attained by hot pressing, an HIP (Hot-Isostatic-Pressing) process, evaporation, etc. In the case of bonding the comparatively thick beryllium material and the comparatively thick carbon-series material together, the hot pressing and the HIP process are preferable. In the case of bonding the comparatively thin beryllium material and the comparatively thin carbon-series material together, the evaporation is preferable. The beryllium material and the nonmetal material can be hot-pressed normally at a temperature ranging from 200° C. up to the melting point of the beryllium material under the normal pressure and under a pressure ranging from 10³ kPa to 10⁵ kPa. The HIP process can be executed normally at a temperature ranging from 100° C. up to the melting point of the beryllium material under the normal pressure and under a pressure ranging from 10⁴ kPa to 10⁶ kPa. The evaporation can be performed when a temperature of a substrate of the carbon-series material ranges from the room temperature up to the melting point of the beryllium material and under a pressure ranging from 10⁻³ Pa to 10⁻⁶ Pa. For instance, the beryllium and the carbon-series material are bonded together by the HIP process at 900° C. or higher, and the beryllium carbide can be produced at the junction interface, thereby enabling the adhesive strength to be improved. Furthermore, e.g., the composite based on bonding the lithium material and the carbon-series material together can be attained by the hot pressing, the HIP process, the evaporation, etc. In the case of bonding the comparatively thick lithium material and the comparatively thick carbon-series material together, the hot pressing and the HIP process are preferable. In the case of bonding the comparatively thin lithium material and the comparatively thin carbon-series material together, the evaporation is preferable. The lithium material and the carbon-series material can be hot-pressed normally at a temperature ranging from the room temperature (23° C.) up to the melting point of the lithium material under the normal pressure and under a pressure ranging from 10³ kPa to 10⁵ kPa. The HIP process can be executed normally at a temperature ranging from the room temperature up to the melting point of the lithium material under the normal pressure and under a pressure ranging from 10⁴ kPa to 10⁶ kPa. The evaporation can be performed when a temperature of a substrate of the carbon-series material ranges from the room temperature up to the melting point of the lithium material and under the pressure ranging from 10⁻³ Pa to 10⁻⁶ Pa. The surface of the target and the surface of the target material can be formed with the grooves and can undergo the corrugated or rugged shaping process by the conventional methods such as the laser ablation, etching and die casting. The materials can be powdered by the conventional methods such as mechanical milling, freeze milling, plasma atomizing and a spray drying method. The beryllium material and the lithium material can be coated over the carbon-series material by, e.g., a CVD (Chemical Vapor Deposition) method. The particles of the beryllium material and the lithium material can be dispersed into the carbon-series material by, e.g., the impregnation method for adjusting the catalyst. The coating based on the CVD method can be carried out by, e.g., a method of letting precursors of the gaseous beryllium material and the gaseous lithium material through the surface of the nonmetal material at a high temperature in an inactive atmosphere and depositing the beryllium material and the lithium material by dint of thermal decomposition of the precursors. The particles of the beryllium material and the lithium material can be dispersed based on the impregnation into the carbon-series material by baking, after water solutions of the precursors of the beryllium material and the lithium material have been impregnated in the porous carbon-series material, the solution-impregnated carbon-series material in a reducing atmosphere and thus bearing the particles of the beryllium material and the lithium material in the minute holes of the carbon-series material. The target configured by stacking the thin layers of the beryllium material (or the lithium material) and carbon-series material can be manufactured by stacking, e.g., a sheet prepared by evaporating the beryllium material (or the lithium material) onto the thick layer of carbon-series material and a sheet prepared in a way that bonds the thin layer of beryllium material (or lithium material) by rolling to the thin layer of carbon-series material so that the beryllium material (or the lithium material) and the carbon-series material alternately abut on each other, and press-molding the stacked layers of these materials in the target shape by the hot pressing, the HIP process, etc.

The thicknesses of the beryllium material and the lithium material in the composite type target according to the present invention can be made by far smaller than, though not particularly limited, a theoretical range of the protons in the beryllium material and the lithium material because the neutron generating reaction due to the collisions of the protons can be shared with the carbon-series material. The reason why so is that the carbon-series material functions as the support material and the cooling material for the beryllium material and the lithium material. Further, it is because the thermal loads burdened on the respective materials are reduced for the reason elucidated above. The theoretical range can be calculated from the incident energy of the protons and stopping power of the substance. For example, when the target material is the beryllium, the theoretical range of the proton having the energy of 11 MeV in the beryllium is approximately 0.94 mm. Therefore, the conventional target composed of only the beryllium requires the thickness equal to or larger than 1 mm. The beryllium material in the target according to the present invention can be, however, made much thinner than 1 mm. When the beryllium material in the target according to the present invention is the beryllium, the thickness of the beryllium is preferably equal to or larger than 0.01 mm but smaller than 1 mm. Further preferably, the thickness of the beryllium is equal to or larger than 0.1 mm but equal to or smaller than 0.5 mm. If the thickness of the beryllium is smaller than 0.01 mm, the heat resistance remarkably declines, and hence it is preferable that the thickness of the beryllium is equal to or larger than 0.01 mm. Moreover, it is preferable for partly sharing the nuclear reaction due to the collisions of the protons with the beryllium that the thickness of the beryllium is smaller than 1 mm. Similarly, when the target material is the lithium, the theoretical range of the proton having the energy of 11 MeV in the lithium is approximately 2 mm. Hence, the conventional target composed of only the lithium requires the thickness equal to or larger than 2 mm. If the lithium material in the target according to the present invention is the lithium, the thickness of the lithium can be, however, made much thinner than 2 mm. The thickness of the lithium in the target according to the present invention is preferably equal to or larger than 0.01 mm but equal to or smaller than 1 mm. Further preferably, the thickness of the lithium is equal to or larger than 0.05 mm but equal to or smaller than 0.5 mm. If the thickness of the lithium is smaller than 0.01 mm, the heat resistance declines, and hence it is preferable that the thickness of the lithium is equal to or larger than 0.01 mm. Moreover, it is preferable for partly sharing the nuclear reaction due to the collisions of the protons with the lithium that the thickness of the lithium is smaller than 1 mm. It is further preferable for keeping the heat resistance and for partly sharing the nuclear reaction due to the collisions of the protons with the lithium that the thickness of the lithium is equal to or larger than 0.05 mm but equal to or smaller than 0.5 mm.

The composite type target according to the present invention does not limit a ratio of the beryllium material (or the lithium material) to the carbon-series material in the thicknesswise direction. The composite type target according to the present invention can adequately set this ratio corresponding to the target material to be used and the acceleration energy of the irradiation protons, and normally sets the thickness of the carbon-series material ten times or more as large as the thickness of the beryllium material (or the lithium material). The main reason why so is derived from a point that the neutron generation efficiency of the carbon-series material is smaller by one or more digits than the neutron generation efficiency of the beryllium material or the lithium material.

In the composite type target according to the present invention, the vacuum seal is applied to the target, and the cooling mechanism formed with the flow path for the coolant is collaterally fitted to the target. The chief reason for applying the vacuum seal to the target is that the target is irradiated with the protons under the vacuum in the present invention and is therefore handled and manipulated under the vacuum. Further, the secondary effect yielded by applying the vacuum seal is for preventing the deterioration caused by the oxidation in the oxidative atmosphere when exposed to the atmospheric air. The vacuum seal may be a seal applied to only a portion exposed to the atmospheric air and may also be a seal applied to the target throughout. Sealing materials preferable for the vacuum seal are, though not particularly limited, light metal materials and the nonmetal materials because of having the property of being harder to undergo the radioactivation than heavy metals. The light metal materials can be exemplified such as magnesium, aluminum, boron, tin, zinc, silicon, alloys of these light metal materials and a variety of ceramic materials but are not limited to these materials. Further, the nonmetal materials can be exemplified such as glasses, epoxy resins and glass reinforced plastics but are not limited to these materials.

Moreover, in the composite type target according to the present invention, the cooling mechanism formed with the flow path for the coolant is collaterally fitted to the target, and the main reason why so lies in that the target is cooled by actually discharging the heat generated at the target efficiently outside the system. The cooling mechanism can be provided on the side surface, in the interior or on the bottom surface of the composite type target. The cooling mechanism is provided on the side surface of the composite type target, in which case the target can be cooled by the water via the heat conductive plate exhibiting the high thermal conductivity as the necessity may arise. In the case of providing the cooling mechanism in the interior of the composite type target, it is preferable that the flow path for the coolant is provided within the carbon-series material in the composite type target. The preferable coolants in this case involve using, e.g., a liquid such as cooling water, and a gas such as gaseous helium having a high coefficient of thermal conductivity. Moreover, the cooling mechanism can be also provided on the bottom surface of the composite type target. In this case, it is preferable to use such a material as to cause almost no problem of the radioactivation caused by the neutrons. This type of material can be exemplified such as the carbon-series material according to the present invention. Further, the composite type target according to the present invention can adopt a cartridge type structure in which the target and the cooling mechanism are built up integrally. This configuration enables the heat generated at the target to be efficiently discharged outside the system and enables the target to be easily detached and replaced with a new target through remote manipulation when the target gets deteriorated.

The neutrons generated by use of the composite type target according to the present invention are the low-energy neutrons containing a large quantity of thermal neutrons or epithermal neutrons. The low-energy neutrons connote the neutrons in which the fast neutrons being harmful and exhibiting the high radioactivation are decreased. The fast neutrons have the energy that is higher by two digits than the thermal neutrons and the epithermal neutrons and are therefore biologically harmful and extremely high in terms of the radioactivation. The neutrons are classified into the fast neutrons (also termed high speed neutrons), the epithermal neutrons, the thermal neutrons and cold neutrons. These neutrons are not, however, clearly distinguished in terms of the energy, and the energy classification differs depending on fields such as reactor physics, shielding, dosimetry, analysis and medical care. For instance, according to “Basic Glossary for Nuclear Emergency Preparedness”, it says that “among the neutrons, the neutron having a large kinetic momentum is called the fast neutron (the high speed neutron), and the neutron called the fast neutron generally has a kinetic energy equal to or larger than 0.5 MeV, though this value differs depending on the fields such as the rector physics, the shielding and the dosimetry”. Further, in the field of the medical care, the epithermal neutrons generally represent the neutrons within a range of 1 eV-10 KeV, and the thermal neutrons generally connote the neutrons having the energy equal to or smaller than 0.5 eV. The low-energy neutrons defined in the present invention represent the neutrons in which the fast neutrons having the kinetic energy equal to or larger than 0.5 MeV are reduced. When the composite type target (the target configured by compositing the lithium material and the carbon-series material) according to the present invention is irradiated with the protons of which the accelerating energy is equal to or larger than 2 MeV but equal to or smaller than 4 MeV, it is possible to generate the neutrons of which the average energy is about 0.3 MeV. Moreover, when the composite type target (the target configured by compositing the beryllium material and the carbon-series material) according to the present invention is irradiated with the protons of which the accelerating energy is equal to or larger than 6 MeV but equal to or smaller than 8 MeV, a quantity of the generation of the fast neutrons of 0.5 MeV or larger can be reduced by at least 30% against the conventional target composed of only the beryllium.

The neutrons can be generated by use of the composite type target according to the present invention and colliding the low-energy protons with this target under the vacuum. The low-energy proton connotes the proton having a threshold value (referred to as the threshold value of the nuclear reaction) of the proton energy capable of causing the nuclear reaction by the collision with the target or having the energy in a range that is about several times as large as the threshold value. Moreover, the reason why the acceleration energy of the irradiation proton is set to the threshold value of the nuclear reaction or set several times as large as the threshold value is for generating the low-energy neutrons with the fast neutrons being reduced. The acceleration energy of the proton needs to be properly set based on the types of the target materials building up the composite type target according to the present invention. In the case of using the beryllium material as the target material, the acceleration energy of the irradiation protons is preferably equal to or larger than 4 MeV but equal to or smaller than 11 MeV and further preferably equal to or larger than 6 MeV but equal to or smaller than 8 MeV. Since the threshold value of ⁷Be (p, n) reaction is about 4 MeV, if the acceleration energy of the protons is smaller than 4 MeV, the generation efficiency of the neutrons is remarkably decreased, and it is therefore preferable that the acceleration energy of the protons is equal to or larger than 4 MeV. Furthermore, if the acceleration energy of the protons exceeds 11 MeV, the radioactivation of the member such as the target gets conspicuous, and, in addition, a large quantity of fast neutrons occurs. It is therefore preferable that the acceleration energy of the protons is equal to or smaller than 11 MeV. The protons, which are further preferable for producing the low-energy neutrons with the reduction of the fast neutrons being harmful and exhibiting the high radioactivation, have the energy that is equal to or larger than 6 MeV but equal to or smaller than 8 MeV. Moreover, in the case of using the lithium material as the target material, the acceleration energy of the irradiation protons is preferably equal to or larger than 2 MeV but equal to or smaller than 4 MeV. Since the threshold value of ⁷Li (p, n) is about 2 MeV, if the acceleration energy of the protons is smaller than 2 MeV, the neutron generation efficiency remarkably decreases, and it is therefore preferable that the acceleration energy of the protons used in the present invention is equal to or larger than 2 MeV. Furthermore, if the acceleration energy of the protons exceeds 4 MeV, the radioactivation of the member such as the target gets conspicuous, and, in addition, the large quantity of fast neutrons occurs. It is therefore preferable that the acceleration energy of the protons is equal to or smaller than 4 MeV. The protons, which are further preferable for producing the low-energy neutrons with the reduction of the fast neutrons being harmful and exhibiting the high radioactivation, have the energy that is equal to or larger than 2 MeV but equal to or smaller than 4 MeV. Moreover, the collisions of the protons with the composite type target under the vacuum is for preventing a decrease in intensity of the irradiation protons and preventing the air pollution. Accordingly, though under the high vacuum to be on the safety side, normally a degree of vacuum is within a range of 10⁻⁴ Pa through 10⁻⁸ Pa.

The neutrons can be generated by a neutron generating apparatus including the composite type target according to the present invention, a hydrogen ion (proton) generating unit for generating the protons, an accelerator for accelerating the protons generated by the hydrogen ion generating unit, and a proton irradiating unit for irradiating the target with the protons accelerated by the accelerator. The neutron generating apparatus can be configured by providing a linear accelerator as the accelerator, using the composite type target according to the present invention as the target and disposing the composite type target in the proton irradiating unit. The hydrogen ion generating unit is provided with a hydrogen ion generator for generating the hydrogen ions. The hydrogen ion generator is not particularly limited but can involve using the conventional hydrogen ion generator. The generated hydrogen ions are transferred to the accelerator for the acceleration. The accelerator is, though being the linear accelerator, not particularly limited if being the linear accelerator but can involve employing the conventional linear accelerator. This type of linear accelerator can be exemplified such as a radio frequency quadrupole linear accelerator, an electrostatic linear accelerator, a normal conduction linear accelerator and a superconducting linear accelerator. The radio frequency quadrupole linear accelerator is a smaller-sized apparatus than the electrostatic linear accelerator nut can generate the protons of a large current. In addition, the radio frequency quadrupole linear accelerator produces an extremely small quantity of radioactive rays such as gamma rays and X-rays and is therefore preferable to the electrostatic linear accelerator. Among the linear accelerators, the linear accelerator serving as a comparatively small-sized linear accelerator and capable of accelerating the protons in a range that is equal to or larger than 2 MeV but equal to or smaller than 11 MeV, is effective in generating the low-energy neutrons with the reduction of the fast neutrons being harmful and exhibiting the high radioactivation. The proton irradiating unit serves to irradiate the target with the protons accelerated by the accelerator and is normally provided with a proton beam adjusting means for converging, diffusing and scanning the protons and implementing the classification with respect to the target for generating the neutrons. The proton irradiating unit is not particularly limited but can involve using a conventional proton irradiating unit equipped with a quadrupole electromagnet or a bending electromagnet.

An in-depth description of an embodiment (which will hereinafter be referred to as “the present embodiment”) will be made by way of one aspect of the present invention with reference to the drawings.

The composite type target according to the present embodiment, which serves to generate the neutrons by colliding the protons with the target, is configured by applying the vacuum seal to the target constructed by compositing the beryllium material (or the lithium material) and the carbon-series material together and collaterally fitting the cooling mechanism formed with the flow path for the coolant to the target. The respective materials of the target have a structure in which the materials are contiguous to each other via the interface. Available targets have the following forms. The targets can be exemplified such as a target configured by bonding the beryllium material (or the lithium material) and the carbon-series material to each other, a target configured by molding a mixture of the powdered beryllium material (or lithium material) and the powdered carbon-series material, a target configured by molding the carbon-series material into which the particles of the beryllium material (or the lithium material) are dispersed, and a target configured by combining and thus bonding both of the beryllium material (or the lithium material) and the carbon-series material, but are not limited to these targets. The carbon-series material may be a single material and may also be a carbon-series composite material formed by compositing a plurality of carbon-series materials. Moreover, the composite type target can adopt such a cartridge type structure that the vacuum seal is applied to the target, and the cooling mechanism formed with the coolant flow path is collaterally fitted to the target. The heat conductive plate can be provided at an intermediate portion between the cooling mechanism and the target according to the necessity.

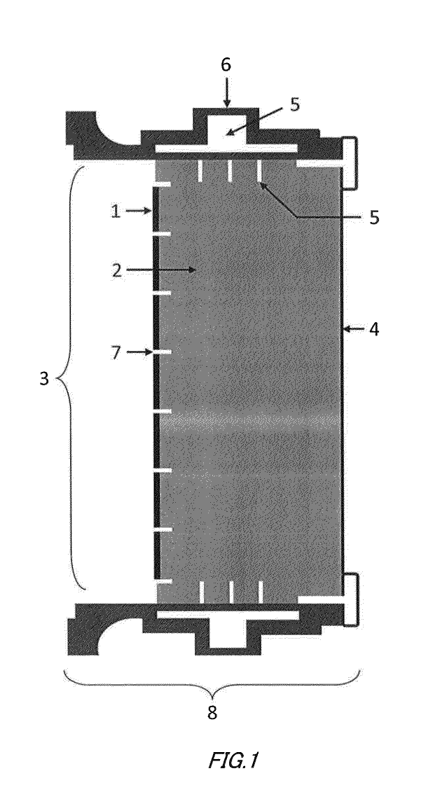

A composite type target 8 according to the present embodiment illustrated in FIG. 1 is configured to include a target 3 taking such a form that a beryllium material (or lithium material) 1 and a carbon-series material 2 are bonded together, and a cooling mechanism 6 formed with a flow path 5 for the coolant and collaterally fitted to the target 3. As the flow path 5 for the coolant, not only a flow path for a liquid coolant but also a flow path for a gaseous coolant can be provided. Then, a vacuum seal 4 for sealing the surface of the carbon-series material positioned on the side of the atmospheric air is applied to the target 3. Further, as the necessity may arise, the composite type target 8 can be formed with a groove 7 for partitioning and adhering the beryllium material (or the lithium material) to a single surface of the carbon-series material.

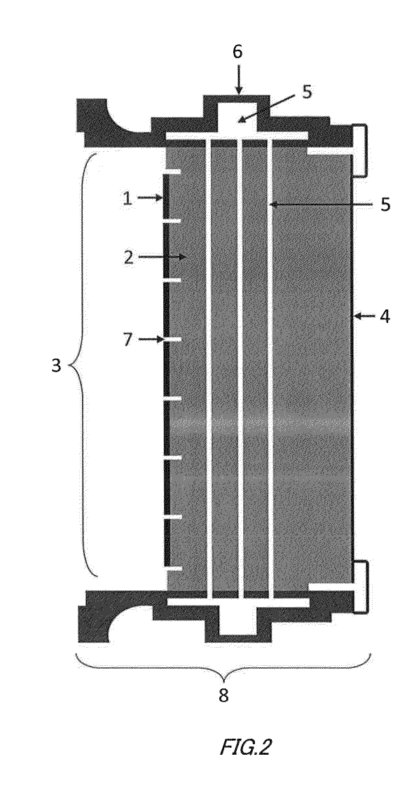

The composite type target 8 according to the present embodiment illustrated in FIG. 2 is configured to include the target 3 taking such a form that the beryllium material (or lithium material) 1 and the carbon-series material 2 are bonded together, and the cooling mechanism 6 formed with the flow path 5 for the coolant and collaterally fitted to the target 3. The flow path for the liquid coolant can be provided as the coolant flow path 5. Then, the vacuum seal 4 for sealing the surface of the carbon-series material positioned on the side of the atmospheric air is applied to the target 3. Further, as the necessity may arise, the composite type target 8 can be formed with the groove 7 for partitioning and adhering the beryllium material (or the lithium material) to the single surface of the carbon-series material.

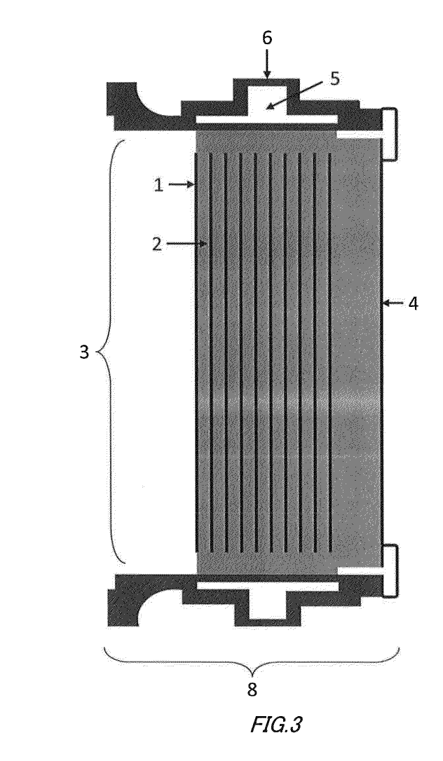

The composite type target 8 according to the present embodiment illustrated in FIG. 3 is configured to include the target 3 taking a form of alternately stacking a layer of the beryllium material (or lithium material) 1 and a layer of the carbon-series material 2, and the cooling mechanism 6 formed with the flow path 5 for the coolant and collaterally fitted to the target 3. The flow path for the liquid coolant can be provided as the coolant flow path 5. Then, the vacuum seal 4 for sealing the surface of the carbon-series material positioned on the side of the atmospheric air is applied to the target 3.

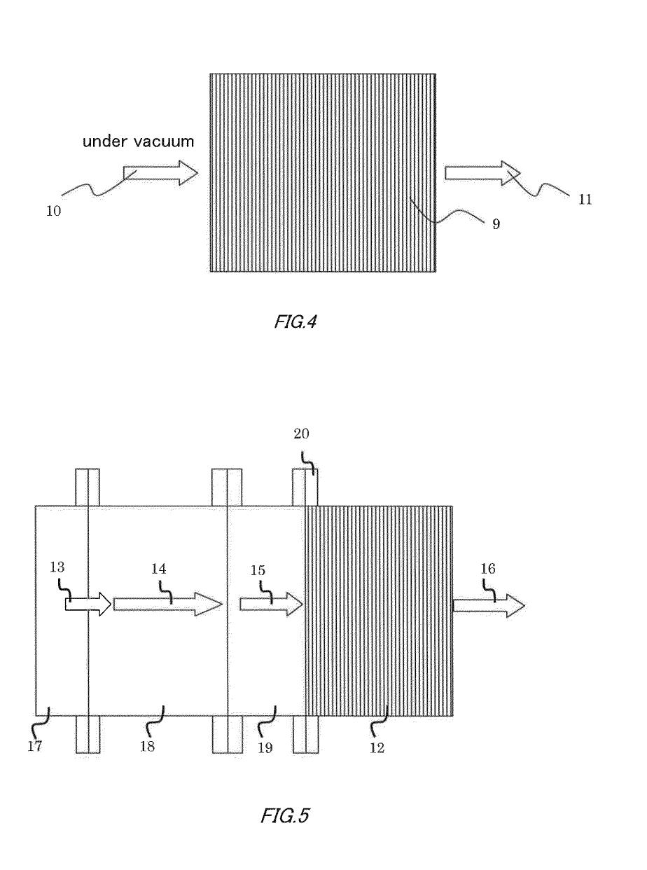

FIG. 4 is a schematic view illustrating a neutron generating method which uses the composite type target according to the present embodiment. As illustrated in FIG. 4, protons 10 having a predetermined acceleration energy (equal to or larger than 2 MeV but equal to or smaller than 11 MeV) are collided with a composite type target 9 according to the present invention under the vacuum, whereby low-energy neutrons 11 can be generated.

FIG. 5 is a schematic view illustrating a neutron generating apparatus method which uses the composite type target according to the present embodiment. As depicted in FIG. 5, in the neutron generating apparatus according to the present embodiment, a hydrogen ion generating unit 17, a linear accelerator 18 and a proton irradiating unit 19 are connected via flanges 20. Then, the proton irradiating unit incorporates a composite type target 12. The hydrogen ion generating unit 17 is provided with a hydrogen ion generator, in which generated hydrogen ions 13 are introduced into and accelerated by the linear accelerator 18. Protons 14 accelerated up to a predetermined energy by the linear accelerator 19 are introduced into the proton irradiating unit 18 connected to a front end portion of the linear accelerator 15 and are collided with the composite type target 12 provided in the proton irradiating unit 19, thereby generating the low-energy neutrons 15. The linear accelerator 18 is not particularly limited if being the linear accelerator capable of generating the protons of which the energy is equal to or larger than 2 MeV but equal to or smaller than 11 MeV. Further, the proton irradiating unit 19 is normally provided with the quadrupole electromagnet or the bending electromagnet.

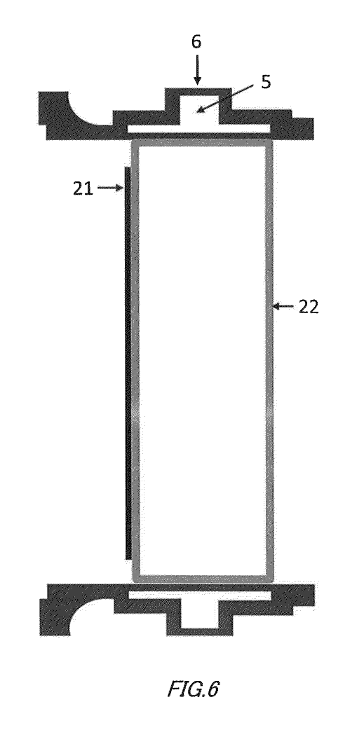

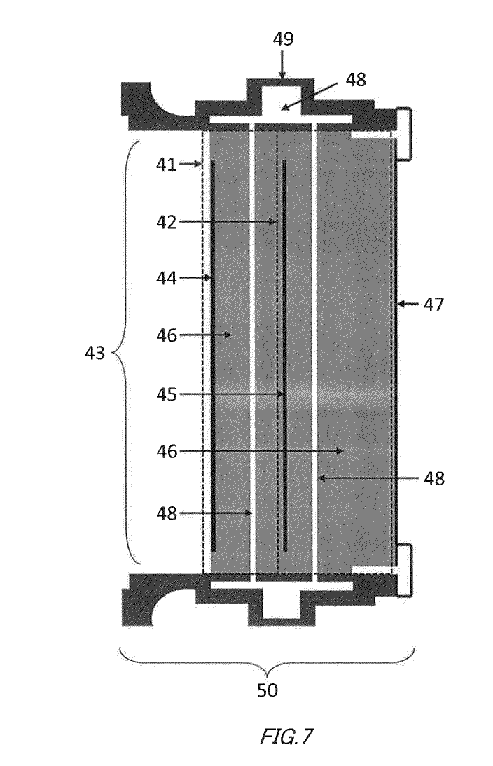

FIG. 6 is a schematic sectional view illustrating a conventional target in which beryllium (or lithium) 21 is adhered to a metallic support member 22. A composite type target 50 depicted in FIG. 7 is configured to include a target unit 43 containing “a composite 41 of a beryllium material 44 and a carbon-series material 46” and “a composite 42 of a lithium material 45 and a carbon-series material 47”, and a cooling mechanism 49 having a vacuum seal 47 and a coolant flow path 48 and collaterally fitted to this target unit 43. In this composite type target 50, however, another coolant flow path 48 provided within the target unit 43 is connected to the coolant flow path 48 of the cooling mechanism 49.

As described above, the present invention provides the new target for generating the neutrons by colliding the protons with the target. As in the embodiment discussed so far, the target is configured by compositing the beryllium material or the lithium material and the carbon-series material together. Therefore, the target is capable of generating the low-energy neutrons with the reduction of the fast neutrons being harmful and exhibiting the high radioactivation, easily discharging the heat generated at the target, efficiently cooling because of the cooling mechanism being collaterally fitted to the target and taking the cartridge type structure in which the target and the cooling mechanism are built up integrally. Hence, the target has a characteristic that this target is provided at the front end portion of the proton irradiating unit and can be easily, when the target gets deteriorated, detached and replaced with the new target through the remote manipulation.

Moreover, as described above, the carbon-series material as the constructive material of the composite type target according to the present invention has the neutron decelerating effect, whereby the generation of the fast neutrons is reduced. With this configuration, in the embodiment discussed so far, the deceleration mechanism for decelerating the generated neutrons can be downsized.

Further, the irradiation protons are the comparatively low energy protons of which the accelerating energy is equal to or larger than 2 MeV but smaller than 11 MeV. Therefore, the effects are acquired, such as remarkably reducing the radioactivation of the member like the target etc due to the protons, restraining the generation of the harmful fast neutrons and enabling the acceleration protons to be generated by the small-sized linear accelerator.

Accordingly, the composite type target according to the present invention is effective as a neutron source of the neutron generating apparatus for the medical care, which can be installed at a small-scale medical institution and generates the neutrons for the medical care such as the BNCT.

### Working Example

The present invention will hereinafter be described specifically by giving working examples and comparative examples.

### First Working Example

The composite type target as illustrated in FIG. 1 is manufactured in a manner that follows. That is, a beryllium sheet (manufactured by Furuuchi Chemical Corporation), which is 150 mm in diameter and 0.5 mm in thickness, is press-fitted onto the single surface of the isotropic graphite (manufactured by Toyo Tanso Co., Ltd. :IG15, a bulk density is 1.9 g/cm³) that is 165 mm in diameter and 50 mm in thickness under HIP process conditions, i.e., at 1000° C. under an argon atmosphere with a press load of 10 tons. Thereafter, an aluminum foil (manufactured by Nippon Kinzoku Co., Ltd.) having a thickness of 0.1 mm is press-fitted to another single surface of the isotropic graphite under the HIP process conditions, i.e., at 1000° C. under the argon atmosphere with the press load of 10 tons, thereby applying the vacuum seal. After this process, further a cylindrical water cooling jacket is soldered to the side portion of the target. The water cooling jacket is capable of flowing 20-liter cooling water per minute at a flow velocity of 2 m per second.

### Second Working Example

The composite type target as illustrated in FIG. 1 is manufactured in a manner that follows. To be specific, a lithium sheet (manufactured by Furuuchi Chemical Corporation), which is 150 mm in diameter and 0.2 mm in thickness, is press-fitted onto the single surface of the isotropic graphite (manufactured by Toyo Tanso Co., Ltd. :IG15, the bulk density is 1.9 g/cm³) that is 165 mm in diameter and 50 mm in thickness under the HIP process conditions, i.e. , at 150° C. under the argon atmosphere with the press load of 10 tons. Thereafter, the aluminum foil (manufactured by Nippon Kinzoku Co., Ltd.) having the thickness of 0.1 mm is press-fitted to another single surface of the isotropic graphite under the HIP process conditions, i.e., at 150° C. with the press load of 10 tons, thereby applying the vacuum seal. After this process, further the same cylindrical water cooling jacket as in the first working example is soldered to the side portion of the target.

### Third Working Example

An experiment for generating the neutrons was performed by using the composite type target in the first working example, the neutron generating method as illustrated in FIG. 4 and the neutron generating apparatus as depicted in FIG. 5. To be specific, the composite type target in the first working example is fitted to the proton irradiating unit provided at the front end portion of the RFQ Linac (Radio Frequency Quadrupole Linac (Linear Accelerator)) having a length of about 6.5 m via the flange so that the beryllium surface is set perpendicular to a proton moving direction, then the accelerating protons having an output of 30 kW and a kinetic energy of 8 MeV are collided with the target under the vacuum of 10⁻⁶ Pa, thereby generating the neutrons. The target is cooled by introducing the 20-liter water of about 5° C. per minute into the water cooling jacket. A degree of the radioactivation of the target after the operation for 100 hours was measured by a survey meter. Further, a post-experiment state of the target was observed.

### Fourth Working Example

The experiment for generating the neutrons was performed by using the composite type target in the second working example, the neutron generating method as illustrated in FIG. 4 and the neutron generating apparatus as depicted in FIG. 5. To be specific, the composite type target in the second working example is fitted to the proton irradiating unit provided at the front end portion of the RFQ Linac having the length of about 6.5 m via the flange so that the lithium surface is set perpendicular to the proton moving direction, then the accelerating protons having the output of 30 kW and the kinetic energy of 3 MeV are collided with the target under the vacuum of 10⁻⁶ Pa, thereby generating the neutrons. The target is cooled by introducing the 20-liter water of about 5° C. per minute into the water cooling jacket. The degree of the radioactivation of the target after the operation for 100 hours was measured by the survey meter. Further, the post-experiment state of the target was observed.

### First Comparative Example

A target made of the beryllium for a comparison as illustrated in FIG. 6 was manufactured in the following manner. To be specific, a beryllium sheet, which is 150 mm in diameter and 0.2 mm in thickness, is press-fitted onto a copper plate that is 165 mm in diameter and 2 mm in thickness under the HIP process conditions, i.e., at 1000° C. under the argon atmosphere with the press load of 10 tons. Thereafter, this plate is screwed to a bottom surface of a cylindrical container (internally hollowed) made of copper, which is 165 mm in diameter, 50 mm in length and 2 mm in thickness. After this process, the same cylindrical water cooling jacket as in the first working example is soldered to the side surface of the cylindrical container.

### Second Comparative Example

A target made of the lithium for the comparison as illustrated in FIG. 6 was manufactured in the following manner. Specifically, a lithium sheet, which is 150 mm in diameter and 0.2 mm in thickness, is press-fitted onto the copper plate that is 165 mm in diameter and 1 mm in thickness under the HIP process conditions, i.e., at 150° C. under the argon atmosphere with the press load of 10 tons. Thereafter, this plate is screwed to the bottom surface of the cylindrical container (internally hollowed) made of the copper, which is 165 mm in diameter, 30 mm in length and 2 mm in thickness. After this process, the same cylindrical water cooling jacket as in the first working example is soldered to the side surface of the cylindrical container.

### Third Comparative Example

The target made of the beryllium in the first working example is fitted to the proton irradiating unit provided at the front end portion of the RFQ Linac having the length of about 6.5 m via the flange so that the beryllium surface is set perpendicular to the proton moving direction, then the accelerating protons having the output of 30 kW and the kinetic energy of 8 MeV are collided with the target under the vacuum of 10⁻⁶ Pa, thereby generating the neutrons. The target is cooled by introducing the 20-liter water of about 5° C. per minute into the water cooling jacket. The degree of the radioactivation of the target after the operation for 100 hours was measured by the survey meter. Further, the post-experiment state of the target was observed.

### Fourth Comparative Example

The target made of the lithium in the second working example is fitted to the proton irradiating unit provided at the front end portion of the RFQ Linac having the length of about 6.5 m via the flange so that the beryllium surface is set perpendicular to the proton moving direction, then the accelerating protons having the output of 30 kW and the kinetic energy of 3 MeV are collided with the target under the vacuum of 10⁻⁶ Pa, thereby generating the neutrons. The target is cooled by introducing the 20-liter water of about 5° C. per minute into the water cooling jacket. The degree of the radioactivation of the target after the operation for 100 hours was measured by the survey meter. Further, the post-experiment state of the target was observed.

### [Simulation Based on Theoretical Calculation]

Simulations of the radioactivation with respect to the materials of the target used in the working examples and the comparative examples were performed in order to theoretically elucidate the experimental results of the working examples and the comparative examples. The simulations were carried out by use of JENDL-4.0 (Non-patent document 4: JENDL-4.0: A New Library for Nuclear Science and Engineering”, J. Nucl. Sci. Technol. 48 (2011) 1-30.) defined as a theoretical calculation program of the nuclear reaction sectional area of the nuclear reaction of the neutrons. Outlines of the calculation results will hereinafter be described.

(1) The nuclear reaction caused by the collisions between the protons of 6 MeV and the beryllium is given such as ⁹Be (p, γ) ¹⁰B, ⁹Be (p, n) ⁹B, ⁹Be (p, pn)⁸Be and ⁹Be (p, α) ⁶Li, in which a radioactive half-life of each of these nuclides is short, and an effective dose equivalent rate constant Γₑ (a measurement unit representing a degree of emission of the gamma rays caused by the radioactivation: μSᵥm²MBq⁻¹h⁻¹) of each of these nuclides was “zero”.

(2) The nuclear reaction caused by the collisions between the protons of 6 MeV and the beryllium is given such as⁶Li (p, γ) ⁷Be, ⁶Li (p, α) ³He, ⁷Li (p, γ)⁸Be, ⁷Li (p, n) ⁷Be and ⁷Li (p,α) ⁴He, in which the radioactive half-life of each of these nuclides is short, and the effective dose equivalent rate constant Γₑ of each of these nuclides was “zero”. Note that the reason why the acceleration energy of the neutrons is set equal to or smaller than 6 MeV is derived from a point that the maximum energy of the neutrons generated by the collisions between the protons of 8 MeV and the beryllium is 6.1 MeV.

(3) The nuclear reaction caused by the collisions between the protons of 3 MeV and the lithium is given such as ⁹Be(n,γ) ¹⁰Be, ⁹Be (n, 2n) ⁸Be and ⁹Be (n, α) ⁶He, in which the radioactive half-life of each of these generated radioactive nuclides excluding ⁷Be is short, and the effective dose equivalent rate constant Γₑ of each of these nuclides excluding ⁷Be was “zero” or “0.00847”.

(4) The nuclear reaction caused by the collisions between the neutrons of 3 MeV and the lithium is given such as⁶Li (n, γ) ⁷Li, ⁶Li (n, p) ⁶He, ⁶Li (n, t) ⁴He, ⁶Li (n, α) ³H and ⁷Li (n,γ) ⁸Li, in which the radioactive half-life of each of these generated radioactive nuclides excluding tritium (t or ³H) is short, and the effective dose equivalent rate constant Γₑ of each of these nuclides excluding the tritium was “zero” or “0.00847”.

(5) The elements producing the radioactive nuclides having the comparatively long radioactive half-life and the comparatively high effective dose equivalent rate constant Γₑ due to the collisions between the neutrons of 6 MeV and the respective elements in the Group 0 (Group 18) elements and Group 1-8 elements in the periodic table, were Sc, Ti, Mn, Fe, Co, Ni, Cu and Pt. Among these elements, the radioactive nuclides produced by the radioactivation of ferrous materials were ⁵⁴Fe(n,p)⁵⁴Mn (the radioactive half-life is 312 days, Γₑ0.111), ⁵⁴Fe (n, α) ⁵¹Cr (the radioactive half-life is 27.7 days, Γₑ0.0046), ⁵⁶Fe(n,p) ⁵⁶Mn (the radioactive half-life is 2.58 hours,Γₑ0.203), and ⁵⁸Fe(n,γ) ⁵⁹Mn (the radioactive half-life is 44.6 days,Γ^{e}0.147); and the radioactive nuclides produced by the radioactivation of copper materials were ⁶³Cu (n, γ) ⁶⁴Cu the radioactive half-life is 12.7 hours, Γₑ0.0259), ⁶³Cu (n, γ) ⁶⁰Co (the radioactive half-life is 5.27 years, Γₑ0.305) and ⁶⁵Cu (n, p) ⁶⁵Ni (the radioactive half-life is 2.52 hours,Γₑ0.0671).

Table 1 illustrates the experimental results of the third and fourth working examples and the third and fourth comparative examples. Further, Table 2 illustrates the results of the simulations based on the theoretical calculations.

TABLE 1

| Working Examples, | | State of |
|---|---|---|
| Comparative | Degree of Radioactivation | Post-Experiment |
| Examples | of Post-Experiment Target | Target |
| Third | Almost No Radioactivation | Melting and |
| Working | | Exfoliation of |
| Example | | Beryllium Are Not |
| | | Observed |
| Fourth | Almost No Radioactivation | Melting and |
| Working | | Exfoliation of |
| Example | | Beryllium Are Not |
| | | Observed |
| Third | Large Radioactivation | Melting and |
| Comparative | | Exfoliation of |
| Example | | Beryllium Are |
| | | Observed |
| Fourth | Large Radioactivation | Melting and |
| Comparative | | Exfoliation of |
| Example | | Lithium Are Observed |

TABLE 2

| | Production of Radioactive |
|---|---|
| Premise Conditions for | Nuclides and Prediction of |
| Theoretical Calculations | Radioactivation |
| Proton: 8 MeV | No Production Radioactive |
| Target: Composite of Beryllium and | Nuclides by Nuclear |
| Graphite | Reaction to Protons |
| | No Radioactivation of |
| | Graphite by Protons and |
| | Neutrons |
| Proton: 8 MeV | No Production Radioactive |
| Target: Bonding of Beryllium and | Nuclides by Nuclear |
| Metal (Copper, Iron, Stainless | Reaction to Protons, but |
| Steel, etc) | Radioactivation of Sc, Ti, |
| | Mn, Fe, Co, Ni, Cu and Pt by |
| | Neutrons Occurs |
| Proton: 3 MeV | No Radioactivation of |
| Target: Composite of Lithium and | Graphite by Protons and |
| Graphite | Neutrons |
| Proton: 3 MeV | Production of Radioactive |
| Target: Bonding of Lithium and | ⁷Be and Tritium due to |
| Metal (Copper, Iron, Stainless | Nuclear Reaction to |
| Steel, etc) | Protons, and |
| | Radioactivation of Sc, Ti, |
| | Mn, Fe, Co, Ni, Cu and Pt |
| | by Neutrons Occurs |

It was confirmed from the results given above that the composite type target according to the present invention could reduce the radioactivation to a greater degree than by the conventional target and exhibited the high heat resistance. Moreover, the experimental results about the radioactivation by the protons and the neutrons were proved theoretically as well.

The composite type target according to the present invention the following characteristics. The composite type target is capable of, because of the target unit being configured by compositing the beryllium material or the lithium material and the carbon-series material, reducing the radioactivation of the member due to the protons and the neutrons, decreasing the generation of the fast neutrons because it is feasible to use the protons having the energy that is comparatively lower than hitherto been, solving the thermal problem of the target owing to compositing the beryllium material or the lithium material and the carbon-series material, discharging the heat generated at the target outside the actual system in the composite type target taking the cartridge type structure in which the target unit and the cooling mechanism are configured integrally, and detaching and replacing the target with the new target safely and easily through the remote manipulation when the target gets deteriorated. Moreover, the neutron generating method and the neutron generating apparatus using the composite type target according to the present invention are capable of generating the low-energy neutrons in a way that employs the small-sized linear accelerator, and hence the composite type target according to the present invention is highly effective in generating the neutrons for the medical care such as the BNCT.

What is claimed is:

1. A composite type target comprising:
a target to generate neutrons by colliding protons with the target and to be configured by compositing a beryllium material and a carbon-series material;
a vacuum seal to be applied to the target; and
a cooling mechanism to be formed with a flow path for a coolant and to be collaterally fitted to the target.

2. A composite type target comprising:
a target to generate neutrons by colliding protons with the target and to be configured by compositing a lithium material and a carbon-series material;
a vacuum seal to be applied to the target; and
a cooling mechanism to be formed with a flow path for a coolant and to be collaterally fitted to the target.
